(19) United States
(12) Patent Application Publication
(10) Pub. No.: US 2015/0358296 A1
(43) Pub. Date: Dec. 10, 2015

(54) CLOUD-BASED SECURE INFORMATION STORAGE AND TRANSFER SYSTEM

(71) Applicant: Royal Canadian Mint/Monnaie Royale Canadienne, Ottawa (CA)

(72) Inventor: David EVERETT, Rustington (GB)

(21) Appl. No.: 14/299,073

(22) Filed: Jun. 9, 2014

(51) Int. Cl. H04L 29/06; H04L 29/08

(52) U.S. Cl. CPC H04L 63/0428; H04L 67/10

(57) ABSTRACT

A cloud based system includes a data network, a cloud host and a data center. A context database stores respective contexts of multiple virtual stores. A log database records transfers of content into and out of each virtual store. At least a portion of the context and log databases is encrypted by the data center. A transfer application executes on the cloud host and responds to a transfer request to transfer content from a virtual store by: retrieving the context of the virtual store from the context database; and forwarding the transfer request and context to the data center. The transfer application also responds to a load request to load content to a virtual store by: retrieving the context of the virtual store, and a log of transfers affecting the virtual store from the log database; and forwarding the load request, context and log to the data center.

### CROSS-REFERENCE TO RELATED APPLICATIONS

This is the first application filed in respect of the present invention.

### MICROFICHE APPENDIX

Not Applicable.

### TECHNICAL FIELD

The present invention relates to secure storage and transfer of information, and in particular to a cloud-based secure information storage and transfer system.

### BACKGROUND

In the modern telecommunications space, so-called cloud-based services are becoming increasingly popular. Cloud-based services typically utilize a cloud host server connected to a data network such as the Internet. The cloud host server typically comprises one or more computer servers or server clusters maintained and operated by a cloud service provider. A client can access the host server to utilize various cloud-based computing and storage services available on the host server.

A typical application of cloud-based services includes on-line cloud-hosted storage of information and records of a client. In such an arrangement, the client contracts with the service provider to use the information processing and storage capacity of the host server to store the client's data. Typically, the costs charged by the service provider will scale with the amount of data being stored by the client, and the specific services being used, such as back-up/restoration and encryption.

Another common application of cloud-based services includes on-line cloud-hosted electronic commerce systems. In such an arrangement, a merchant may use the host server to execute an e-commerce application which enables clients to browse a catalogue, select items to purchase, enter shipping and billing information, and complete payment for their purchase order. In this case, the client (merchant) is utilizing both the storage capacity of the host server (e.g. for catalogues) and its computational power to properly handle multiple purchase transactions simultaneously.

Cloud-based services are attractive for cloud-hosted storage and e-commerce because the host servers offer very high availability and scalability, with the ability to process and store enormous amounts of information. For a client primarily using storage services, this means that they can use the cloud-based services to store all of their records, and can access those records from any device connected to the network. In the case of a company or organization, the high availability offered by the cloud server means that any or all of the company's members may access the data at any given time. For an e-commerce client, the high availability offered by the cloud server means that large numbers of transactions can be handled simultaneously.

However, cloud-based services suffer a limitation in that data stored on a host server is vulnerable to un-authorized access and other forms of misuse. This difficulty arises from the fact that a client must trust a legally unrelated party (in this case the service provider) to ensure the security and integrity of the client's data. In order to address this, the client may use passwords or other authentication methods to try to control access to their account and/or data. However, in this case, the authentication algorithms are executed on the host server, and the passwords and/or other authentication information will be received by the host server during a user log-on process. The client must trust that the service provider will not manipulate the authentication algorithms or misuse the authentication information provided by the user.

In addition, the user may encrypt their data to provide an additional layer of security. For example, a client may encrypt their data stored in a cloud-hosted database. In another example, a merchant may use a secure payment module which uses encrypted messaging to convey a customer's financial information. However, in both of these cases the encryption algorithms are executed on the host server, and the keys will be stored on the host server at least for the duration of a user session. The client must trust that the service provider will not manipulate the encryption algorithms (e.g. to provide a “back-door”) or misuse the keys stored on the server during a user session.

In order to address these challenges, some clients use cloud-based services for non-critical information only, and maintain their own secure servers for critical information. Hardware Security Modules (HSMs) are commercially available secure computer systems that are particularly well suited for implementing secure servers. However, HSMs suffer disadvantages in that they are expensive, and have a limited storage capacity. The limited storage capacity naturally limits the size of the database that they can maintain, which in turn limits the number of users that can be supported by any given HSM unit. The high cost of HSMs means that increasing the number of supported users by increasing the number of HSMs tends to be very expensive. This problem is compounded by the fact that a client may need to maintain duplicate databases (and thus HSMs) to provide data redundancy and automated fail-over in the event of an HSM failure.

Techniques that address at least some of the above-noted limitations of the prior art remain highly desirable.

### SUMMARY

Accordingly, an aspect of the present invention provides an secure cloud-based data storage and transfer system. The system includes a data network, a cloud host connected to the data network, and a secure data center connected to the data network. The cloud host is configured to provide cloud-based data storage and computing services to clients through the data network. The secure data center is configured to provide secure encryption, decryption and data processing functions. A database stored on the cloud host includes data that is cryptographically protected by the secure data center. A lightweight application executing on the cloud host receives a request message including an identifier. The lightweight application uses the identifier to retrieve one or more records from the database, and forwards the request message and the retrieved records to the data center. The lightweight application receives records from the data center, and saves the records in the database.

Another aspect of the present invention provides an electronic content storage and exchange system. The System includes a data network, a cloud host connected to the data network, and a data center connected to the data network. The cloud host is configured to provide a computing service to subscribers through the data network. The data center is configured to provide secure encryption, decryption and data processing functions. A context database stored on the cloud host contains context information defining a respective context of each one of a plurality of virtual stores. At least a portion of the context information is cryptographically protected by the data center. A lightweight secure transfer application executes on the cloud host and is configured to respond to a request message to transfer content to or from a subscriber's virtual store by: retrieving a record representing a respective context of the subscriber from the context database; and forwarding the transfer request message and the retrieved record to the data center. The secure transfer application is also configured to save records received from the data center in the context database.

In some embodiments, the lightweight application emulates a conventional cloud-based service, such as an e-commerce or electronic payment application. In this arrangement, clients may exchange messaging with the lightweight application in a conventional manner to access and use the service being emulated by the application. However, in accordance with the present technique, data associated with the service is stored in cryptographically protected database maintained on the cloud host, while computing operations of the service are performed in the secure data center. Security of the data saved in the database is provided by the encryption algorithms and keys that are stored and used locally within the data center. The data center may be managed by the owner of the data, or a service provider contracted to secure the data on behalf of the data owner.

An advantage of the present technique is that it combines the benefits of cloud-based services with enhanced security afforded by locally held encryption keys and algorithms.

### BRIEF DESCRIPTION OF THE DRAWINGS

Further features and advantages of the present invention will become apparent from the following detailed description, taken in combination with the appended drawings, in which:

FIG. 1 is a block diagrams schematically illustrating a message exchange system in accordance with a representative embodiment of the present invention;

FIG. 2 schematically illustrates a representative context database usable in the embodiment of FIG. 1;

FIGS. 3A and 3B are message flow diagrams schematically illustrating a possible scenario for completing an e-commerce transaction in the embodiment of FIGS. 1 and 2; and

FIGS. 4A and 4B are flowcharts schematically illustrating representative steps and process rules implemented in the HSM manager and HSMs of FIG. 1.

It will be noted that throughout the appended drawings, like features are identified by like reference numerals.

### DETAILED DESCRIPTION

The present invention provides methods and systems for cloud-based data storage and transfer. In the description below, the present technique is described by way of an example embodiment in which a cloud-based payment service is implemented. However, it will be appreciated that the present technique is not limited to such embodiments. Rather, it will be appreciated that the present techniques may be advantageously used to implement any cloud-based service in which it is desired to securely store and/or transport information using a cloud host.

In very general terms, the present technique provides a secure system that maintains a local set of secret keys and encryption/decryption functions, which enables data to be cryptographically secured. A lightweight application that executes on a cloud host server interacts with the secure system to store cryptographically secured data on the cloud host system. With this arrangement, the high availability and scalability of the cloud host system is used for data storage, but the data is secured by cryptographic keys and algorithms that are locally maintained on the secure system. As a result, the owner of the secure system does not need to trust security features offered by the cloud host system.

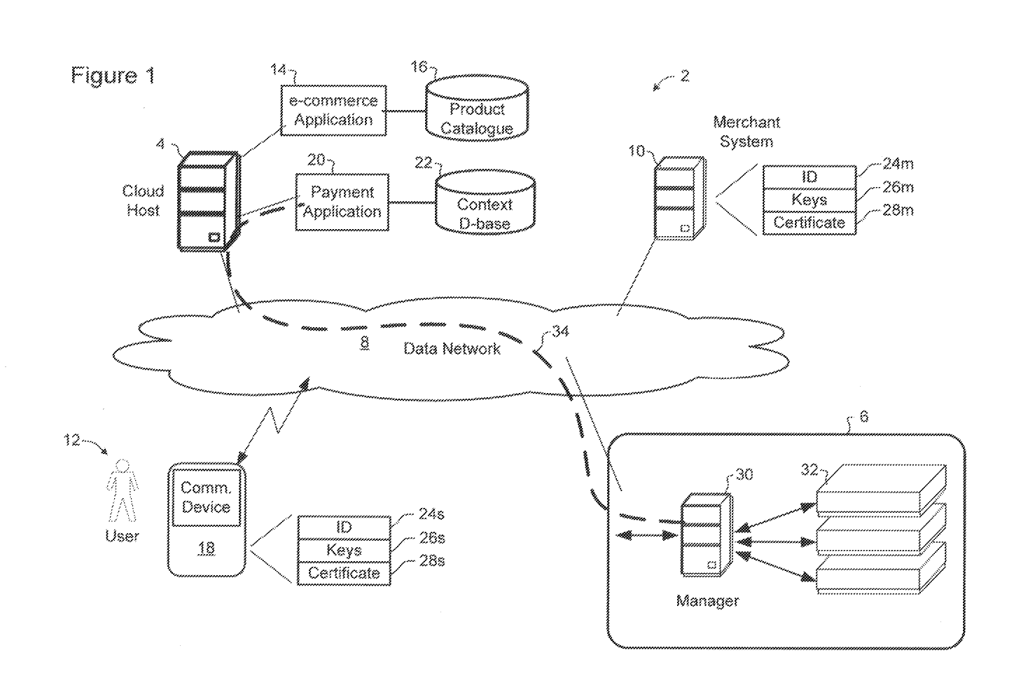

Referring to FIG. 1, a representative cloud-based secure information storage and transfer system 2 in accordance with the present invention comprises a cloud host system 4 and a secure system represented by a data center 6, both of which are connected to a data network 8, such as, for example, the Internet. Merchant systems 10 and individual users 12 may interface with the cloud host system 4 to access and use cloud based applications, such as e-commerce applications, for example.

The cloud host system 4 may be managed by a cloud service provider and may comprise one or more servers or server clusters configured to provide computing and storage services to a plurality of subscribers of the cloud service provider. Cloud host systems of a type usable in the present technique are well known, and cloud hosted services are readily available from several cloud service providers (such as, for example, Amazon.com, and Google.com).

Users of cloud-based systems and services may broadly be divided into content or service providers, and consumers. Typically, content providers will enter into a subscription contract with a cloud service provider, and will then use the cloud host 4 to offer cloud-based services to consumers. In the example of FIG. 1, content providers may include a merchant and a payment services provider. The merchant may enter into a subscription contract with the cloud service provider, and so use the cloud host 4 to execute an e-commerce application 14 offering the merchant's products for sale. The e-commerce application 14 may use a database 16 stored on the cloud host 4 and containing one or more catalogues of products that can be purchased from the merchant. Similarly, the payment services provider may enter into a subscription contract with the cloud service provider, and use the cloud host 4 to execute a payment application 20 for enabling monetary transactions between subscribers of the payment services provider.

The merchant may enter into a subscription contract with the payment services provider so that consumers may use the payment functions offered by the payment services provider to complete their purchase transactions. For example, an individual user 12 may use their communication device 18 to access the e-commerce application 14, which then may permit the user 12 to browse the catalogue and select items the user 12 wishes to purchase. Once the user 12r has selected their items, the e-commerce application 14 may access the payment application 20 in order to complete the purchase transaction.

The user 12 may, or may not be a subscriber of either the cloud host service provider or the merchant. However, it is contemplated that both the merchant and the user 12 will have to be a subscriber of the payment services provider in order to complete monetary transfers using the payment services provider's system.

As part of their subscription to the payment service provider, the payment service provider may initialize a respective virtual store for each subscriber, which can be used in a manner analogous to a wallet to store value owned by that subscriber. Preferably, each virtual store is associated with a unique identifier 24, encryption keys 26, and a digital certificate 28. In addition, the payment service provider may initialize a respective record associated with each virtual store in a context database 22. In some embodiments, the encryption keys 26 may comprise a public/private key pair. As may be seen in FIG. 1, the respective virtual store Identifier 24, keys 26 and Digital Certificate 28 assigned to each subscriber's virtual store can be supplied to each subscriber (in this case the merchant and the user) for use in transactions. In the embodiment of FIG. 1, the merchant's ID 24m, keys 26m and Certificate 28m are saved on the Merchant system 10, while the user's ID 24s, keys 26s and Certificate 28s are saved on the subscriber's communication device 18. If desired, the encryption keys and digital certificate may be issued by a trusted issuing authority, such as, for example, Verisign. However, this is not essential.

In the illustrated embodiment, the payment services provider manages the data center 6, generally comprises a manager 30 connected to one or more secure servers 32. In general, the manager 30 controls the flow of messages into and out of the data center 6. In some embodiments, the manager 30 distributes messaging across the secure servers 32, for example to provide load balancing or redirection in the event of a failure of one of the secure servers 32. In some embodiments, the manager 30 may also provide encryption and decryption services, as will be described in greater detail below. In some embodiments, the manager 30 is provided as a Hardware Security Module (HSM) of a type known in the art and commercially available, and executing suitable software to implement the appropriate functionality. In some embodiments, each of the secure servers 32 within the data center 6 are provided as Hardware Security Modules (HSMs).

Security of the data center 6 is enhanced by configuring the manager 30 to only exchange messages with the Payment Application 20. One way of accomplishing this is to establish and maintain a secure connection 34 or Virtual Private Network (VPN) between the manager 26 and the Payment Application 20 using a known tunnelling protocol, for example. With this arrangement, the manager 30 can be configured to accept and send messages through the secure connection 34, and to discard messages received via the data network 8 from any other source. The security of the data center 6 may also be enhanced by ensuring that the network address of the data center 6 is known only to the Payment Application 20, and is not advertised to the network.

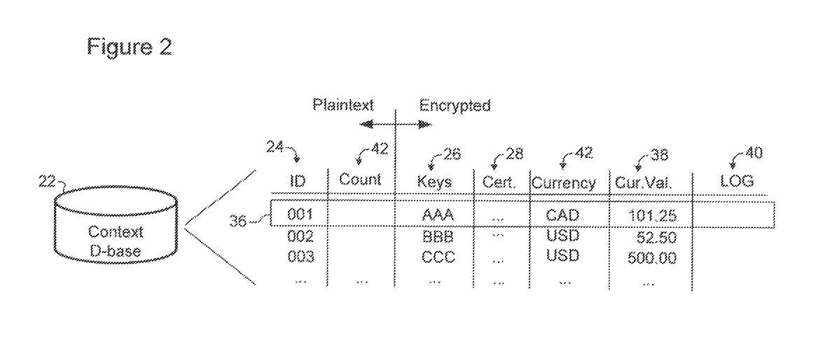

FIG. 2 illustrates a viable format of the Context database 22, although other formats may be used, if desired. In the embodiment of FIG. 2, the Context database 22 is formatted into records 36, each record 36 representing a respective virtual store associated with a subscriber, and containing fields for storing the respective ID 24, Keys 26 and Certificate 28 uniquely assigned to the virtual store, a current content (Cur.Val) 38 and a log 40. The Keys 26 and Certificate 28 facilitate cryptographic security functionality such as encryption and digital signature using, for example, well-known Public Key Infrastructure (PKI) techniques. The log 40 contains information relating to each transaction executed by or on behalf of the virtual store. In some embodiments, this information may include the at least a portion of each value transfer message generated or received by the virtual store, as will be described in greater detail below.

In some embodiments, each record 36 of the context database 22 may also include a field identifying a currency 42 of the current content 38, and a count 42 of transactions that have been completed by (or on behalf of) the virtual store represented by that record 36. Taken together, the contents of a record 36 provides the context of a respective virtual store assigned to a subscriber. In order to ensure integrity of data stored in the database, each record is preferably cryptographically protected by the data center 6 using a combination of encryption, checksums and digital signatures. Preferably, the ID field 24 is unencrypted, so that the payment application 20 can readily use the store ID contained in received messages (as will be described in greater detail below) to retrieve a record 36 (or “virtual store context”) from the context database 22 using well known techniques. Preferably, at least the Keys 26 are encrypted using one or more secret keys maintained locally by the data center 6. In some embodiments, one or more other fields, such as the certificate 28 and the current content (Cur.Val) 38 may also be encrypted. This arrangement is beneficial, in that it allows any given record 36 to be readily retrieved from the Context Database 22, and updated using known techniques; but at the same time maintains security by ensuring that it is computationally infeasible for any party other than the data center 6 to modify its contents or read its secret data.

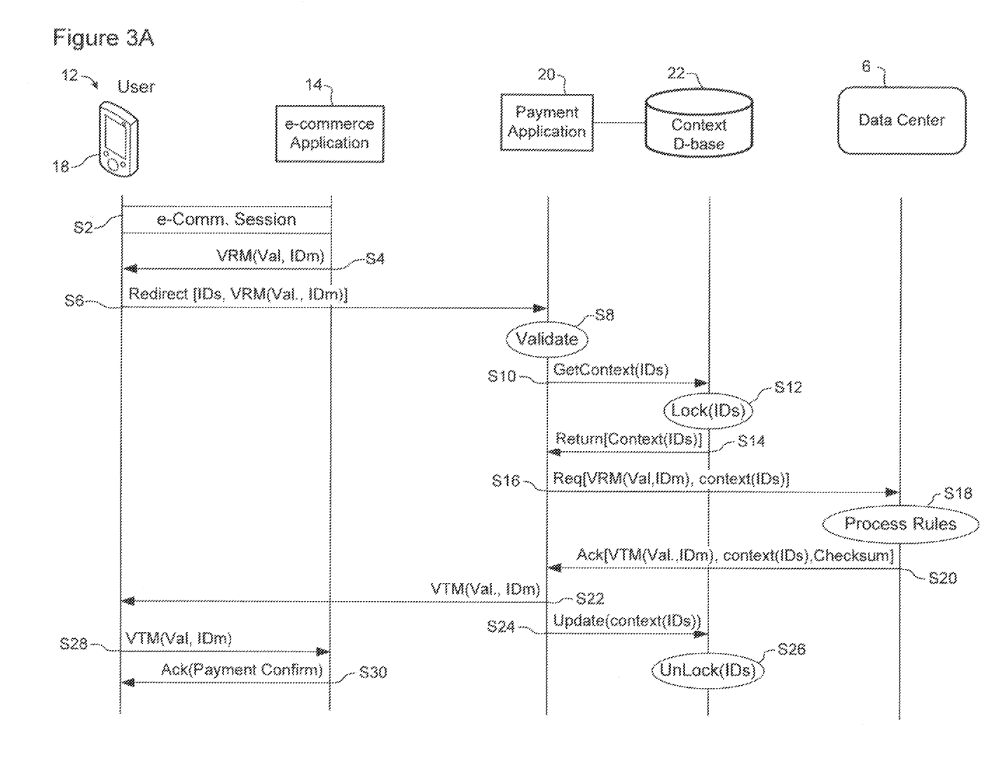

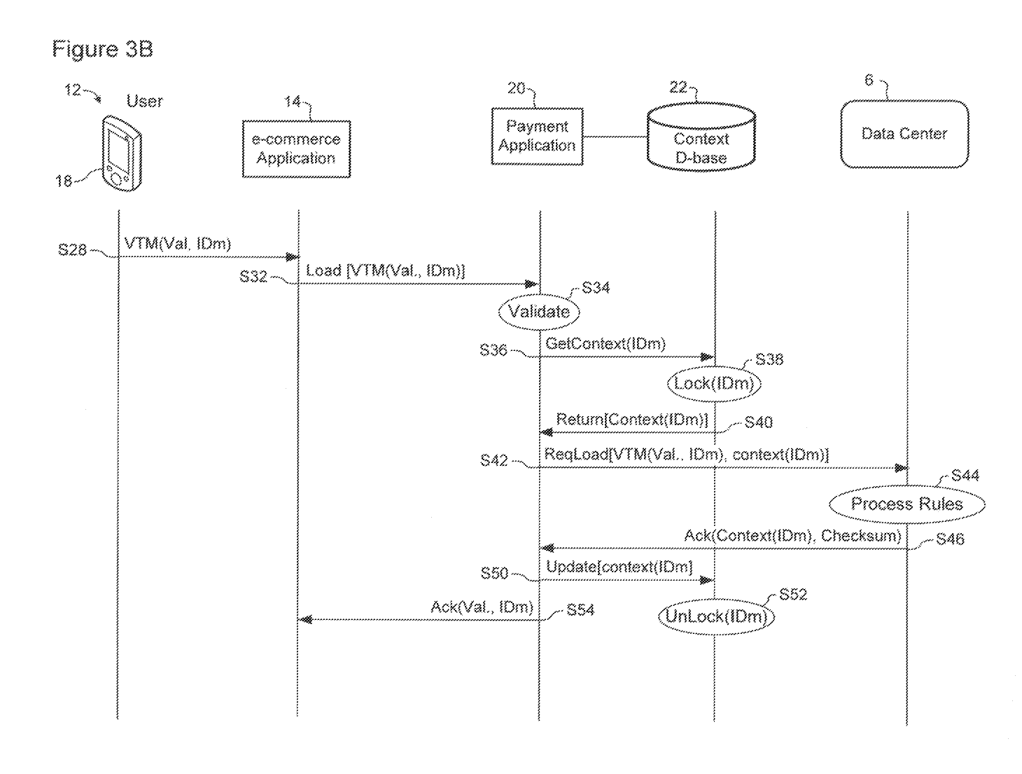

FIG. 3A is a message flow diagram illustrating an example operation of the present technique for the case of an e-commerce transaction implemented in the system of FIG. 1. Referring to FIG. 3A, in a first step (S2), a user 12 uses their communications device 18 to access the merchant's e-commerce application 14, browse the merchant's product catalog, and select an item to purchase, all in a conventional manner. Based on the user's purchase selection, the e-commerce site 14 initiates a payment sequence, by formulating a Value Request Message (VRM) containing the ID 24m of the merchant's virtual store as the intended recipient, and the payment amount owing as the content to be transferred, and sends this VRM to the user's communication device 18 (at S4). Upon receipt of the VRM, the subscriber's communication device 18 redirects the VRM to the Payment Application 20 (at S6). In some embodiments, the redirected VRM may also include the ID 24s and Certificate 28s of the user's virtual store.

Upon receipt of the redirected VRM from the user's communication device 18, the Payment Application 20 may perform verification process (at S8) to confirm the subscriber's ID 24s and Certificate 28s. In some embodiments, the Payment Application 20 may also attempt to obtain confirmation of the User's acceptance of the transaction. In some embodiments, the verification processes may be handled within secure connections (for example Secure Sockets Layer, SSL, connections) set up for this purpose between the Payment Application 20 and either one or both of the e-commerce application 14 and the Cloud Host 4. In some embodiments, the Payment Application 20 may obtain information of the transaction (e.g. user's ID 24s and the transaction amount) from the e-commerce application 14. In some embodiments, the Payment Application 20 may obtain confirmation of the user's authentication status from either the cloud host 4 or the e-commerce application 14. In cases where the user 12 has already completed log-in and/or authentication processes with either or both of the cloud host 4 and the e-commerce application 14, it may not be necessary for the Payment Application 20 to request the user 12 to complete further authentication steps in order to complete the transaction. However, if desired, these further additional authentication steps may be performed using known techniques.

Upon successful completion of the verification process, the Payment Application 20 requests (at S10) the user's virtual store context from the context database 22. Preferably, the database record 36 representing the subscribers' virtual store is locked (at S12) to prevent another process from accessing or revising that record before completion of the current transaction. In some embodiments, the record 36 may be locked by the database engine (not shown), in response to the request message from the Payment Application 20. In other embodiments, the record may be locked by the Payment Application 20 itself, for example by means of suitable control messages. Upon receipt of the subscriber's virtual store context from the VSM context database 22 (at S14), the Payment Application 20 forwards the VRM and the subscriber's context (at S16) to the data center 6 for processing.

Upon receipt of the VRM and the subscriber's context, the manager 30 may decrypt and/or validate the integrity of the user's context, and pass the VRM and the decrypted context to a secure server 32 for processing. Alternatively, the manager 30 may pass the encrypted context and the VRM to a secure server 328, which will then decrypt the context prior to processing the VRM. In either of these embodiments, the secure server 32 processes the VRM and the decrypted context (S18) in accordance with a set of processing rules (described in greater detail below), to generate (S20) at least: a value transfer message (VTM) for conveying the payment amount owing to the Merchant and an updated version of the user's context. These items are passed back to the manager 30 for forwarding to the Payment Application 20 (at step S20). In embodiments in which the secure server 32 performs encryption/decryption functions, at least a portion of the updated user's context may be encrypted and/or secured using cryptographic checksums by the secure server 32 prior to passing them to the manager 30. In other embodiments, the manager 30 may encrypt and/or generate checksums or digital signatures securing portions of the updated context prior to forwarding it to the Payment Application 20.

In some embodiments, the secure server 32 may also generate one or more checksums, signatures or other validation data, which may be passed to the manager 30 and/or the Payment Application 20 so that the integrity and/or uniqueness of the VTM and updated user's context can be verified.

Upon receipt of the VTM and updated user's context from the manager 30, the Payment Application 20 may forward the VTM to the subscriber's communication device 18 (at S22). The updated context may then be stored (at S24) in the appropriate record 36 of the context database 22, and that record unlocked (at S26) to permit other transactions

Upon receipt of the VTM from the Payment Application 20, the user's communication device 18 can forward the VTM to the e-commerce application 14 (at S28) in order to complete the transaction. A representative process for completing a transaction following receipt of the VTM by the e-commerce application 14 is described below with reference to FIG. 3B. Upon successful completion of that process, an acknowledgment message may be sent (at S30) to the user's communication device 18. A corresponding acknowledgment message may also be sent by the e-commerce application 14 to the Merchant's system 10.

Referring to FIG. 3B, when the e-commerce application 14 receives a VTM from a user's communication device 18 (at S28), it formulates and sends a load request message (at S32) containing the VTM to the Payment Application 20.

Upon receipt of the VTM from the e-commerce application 14, the Payment Application 20 may perform a verification process (at S34) to confirm the integrity of the VTM. In some embodiments, the verification process may use the User's Certificate 28s and/or checksums contained in the VTM to verify that the VTM content has not been changed since it was generated.

If the validation process fails, the payment application 20 may discard the VTM and the Load request message. In some embodiments, the payment application may return a failure notification message (not shown) to the e-commerce application 14.

Upon successful completion of the verification process, the Payment Application 20 requests the Merchant's virtual store context from the context database 22 (at S36). Preferably, the context database record 36 representing the Merchant's virtual store is locked (at S38) to prevent another process from accessing or revising that record before completion of the current transaction. In some embodiments, the record may be locked by the database engine (not shown), in response to the request message from the Payment Application 20. In other embodiments, the record may be locked by the Payment Application 20 itself, for example by means of suitable control messages. Upon receipt of the Merchant's virtual store context from the context database 22 (at S40), the Payment Application 20 forwards the VTM and the Merchant's context to the data center 6 (at S42) for processing.

Upon receipt of the VTM and the Merchant's context, the manager 30 may decrypt and/or validate the integrity of the Merchant's context, and pass the VTM and the decrypted context to a secure server 32 for processing. Alternatively, the manager 30 may pass the encrypted context and the VTM to a secure server 32, which will then decrypt the context prior to processing the VTM. In either of these embodiments, the secure server 32 processes (at S44) the VTM and the decrypted context in accordance with a set of processing rules (described in greater detail below), to generate at least: an acknowledgment message indicating success or failure of the transaction; and an updated version of the Merchant's context. These items are passed back to the manager 30 for forwarding to the Payment Application 20 (at S46). In embodiments in which the secure server 32 performs encryption/decryption functions, at least a portion of the updated Merchant's context may be encrypted by the secure server 32 prior to passing them to the manager 30. In other embodiments, the manager 32 may encrypt portions of the updated Merchant's context prior to forwarding them to the Payment Application 20.

In some embodiments, the secure server 32 may also generate one or more checksums, signatures or other validation data, which may be passed to the manager 30 and/or the Payment Application 20 so that the integrity of the updated subscriber's context can be verified.

Upon receipt of the Acknowledgment message and updated Merchant's context from the manager 30, the Payment Application 20 may store the updated Merchant's context in the appropriate record 36 of the context database 22 (at S50), and unlock that record (at S52) to permit other transactions. In a scenario in which the Acknowledgment message indicates that the transaction was successful, corresponding acknowledgment messages may be sent (at S54) to any one or more of the e-commerce application 14, the user's communication device 18 and/or the merchant system 10 to indicate that the transaction has been successfully completed. On the other hand, if the Acknowledgment message indicates that the transaction was not successful, the Payment Application 20 may send failure messages to any one or more of the user's communication device 18, the merchant system 10, and the e-commerce application 14 so that the user's purchase may be cancelled or other steps taken to identify and rectify the problem.

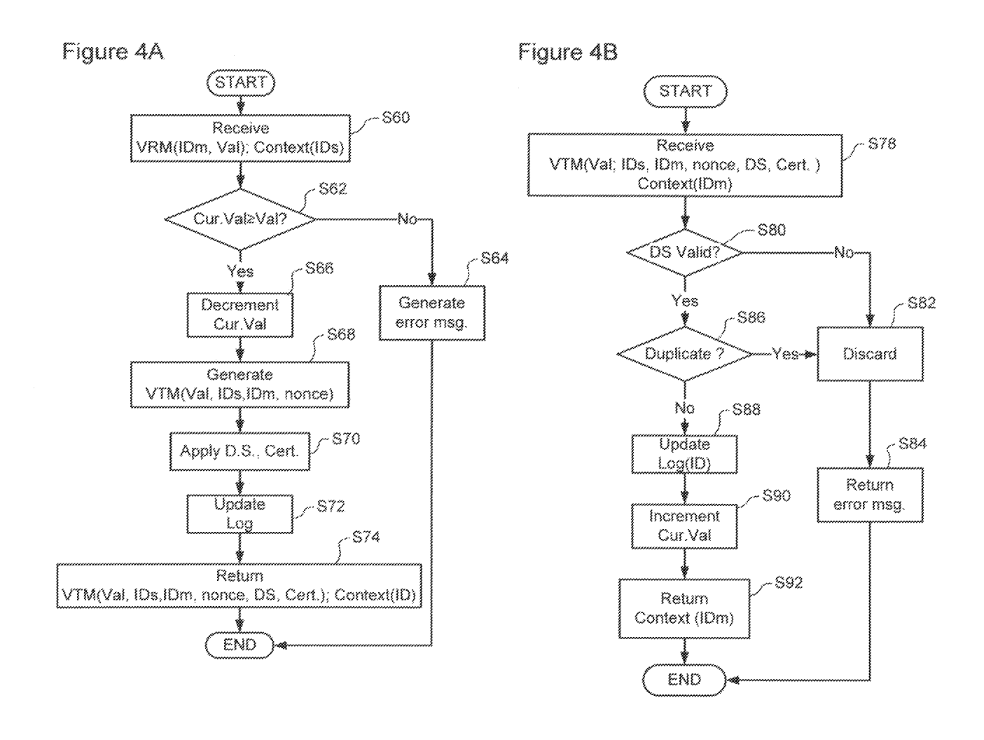

In the process described above with reference to FIG. 3A, the secure server 32 processes a VRM and the user's context in accordance with a set of processing rules at step S18, to generate at least a VTM, and an updated version of the user's virtual store context. Similarly, in the process described above with reference to FIG. 3B, the secure server 32 processes a VTM and the Merchant's context in accordance with a set of processing rules at step S44, to generate at least an Acknowledgment message and an updated version of the Merchant's context. Representative process rules for each of these operations are described below with reference to FIGS. 4A and 4B, respectively.

FIG. 4A is a flow chart illustrating representative processing rules for processing a VRM and a user's context to generate a VTM and an updated version of the user's context. As may be seen in FIG. 4A, the process begins with the secure server 32 receiving the VRM and decrypted user's context. Upon receipt of the VRM (at S60), the secure server 32 compares (at S62) the content (Val.) to be transferred with the current content (Cur.Val) 38 stored in the user's context. If Cur.Val 38 is less than the content to be transferred (Val.), then the secure server 32 generates and returns an error message (at S64). Otherwise, the secure server 32 decreases the Cur.Val 38 by the content (Val.) to be transferred (at S66), and then generates (at S68) a Value Transfer Message (VTM) containing the content (Val.) to be transferred, the ID 24s of the user's virtual store, the ID 24m of the merchant's virtual store and a nonce which uniquely identifies the VTM, at least among the content transfer messages generated and sent on behalf of the user's virtual store. The secure server 32 then applies a Digital Signature (DS) and the user's Certificate 28 to the VTM (at S70). The secure server 32 then records information about the transfer in the Log field 40 of the user's context (at S72). Finally, the secure server 32 returns (at S74) the digitally signed VTM and the updated context to the Manager 30.

In the embodiment of FIG. 4A, the VTM generated by the secure server 32 (at S68) contains the ID 14s of the user's virtual store. However, this is not essential. In some embodiments, the user's virtual store ID 14s may be omitted, if desired.

In the embodiment of FIG. 4A, the VTM generated by the secure server 32 (at S68) contains a nonce. In general, the nonce can be any binary or alpha-numeric string that enables a recipient party to verify the uniqueness of the VTM, at least among VTMs generated by or on behalf of the user's virtual store. In some embodiments, the nonce may be generated by the secure server 32 as part of the VRM processing. However, this is not essential. In some embodiments, the nonce may be generated by the recipient party (eg the Merchant's system 10) prior to initiation of the transaction, and included in the VRM generated by the e-commerce application 14 (FIG. 3A, at S4). This arrangement is beneficial, in that enables the Merchant to positively associate any given VTM loaded to its virtual store to a specific purchase transaction, without altering the ability of the secure server 32 to detect and handle duplicates.

FIG. 4B is a flow-chart showing a representative process which may be executed by the Data Center 6 to load value contained in a received VTM message to a subscriber's (in the illustrated example, the merchant's) virtual store. Referring to FIG. 4B, the process begins with the secure server 32 receiving the VTM and decrypted Merchant's context. Upon receipt of the VTM (at S78), the secure server 28 uses the Certificate 28 to verify (at S80) the digital signature of the received VTM. If the verification fails, the VTM is discarded (at S82), and an error message is returned (at S84) to the Manager 30 before the process is terminated. If the verification is successful, the secure server 32 uses the nonce and both the user's context ID 24s and the merchant's context ID 24m to compare (at S86) the received VTM with the decrypted Merchant's log field 40 to determine whether the VTM is a duplicate of a VTM previously received from the user's virtual store. If it is a duplicate, the VTM is discarded (at S82), an error message is returned to the Manager 30 (at S84) and the process is terminated. Otherwise, the secure server 32 updates the merchant's log 40 with a transaction record including information about the transaction (at S88), and increases the current content (Curr.Val) 36 stored in the Merchant's context by the content (Val.) contained in the VTM (at S90). Finally, the secure server 32 returns (at S92) an acknowledgment message and the updated Merchant'e context to the HSM manager 26, indicating that the VTM message has been successfully processed.

As noted above, the log field 40 maintains a record of content transfers into and out of each virtual store. In some embodiments, the information recorded in the log field 40 comprises the content of each transfer message received of sent by (or on behalf of) each virtual store. In some embodiments, a digest of each transfer message may be recorded, rather than the entire message. In some cases, the digest may take the form of a hash computed over at least a portion of a respective transfer message. Recording a hash of received transfer messages, for example, enables effective detection of duplicate messages while minimizing the amount of memory required to store the log field 40. In some embodiments, sent and received Value Transfer Messages may be recorded in respective separate log fields. This arrangement is beneficial in that it facilitates respective different information sets to be recorded in each field. For example, the log field for sent messages may record the entire VTM sent by a given virtual store, while the log field for received messages merely records a hash of each received message.

In some embodiments, it may be desirable (or, for regulatory reasons, essential) that the service provider have knowledge of the actual identities of each of its subscribers. In such cases, anonymity of the parties involved in a transaction is not preserved, because either the host server 4 and/or the manager 30 is capable of tracking transactions involving each of its subscribers. However, this is not essential. For example, a service provider could accept anonymous requests for virtual storage media. However, it will be seen that the entire on-line purchase transaction described above in reference to FIG. 3 proceeds entirely on the basis of the respective ID 24 and certificate 28 issued to the user and the merchant. This information identifies the particular virtual stores involved in the transaction, and also provides the values of non-repudiation, non-revocability, message integrity and message security, but it does not provide information of the actual identities of the involved parties. As such, unless the service provider has some other process for acquiring information identifying each of its subscribers and the and ID 24 and certificate 28 issued to the virtual store of that subscriber, the service provider would not have any means of identifying the parties to a transaction, and anonymity is preserved.

In the foregoing description, the present technique is described in terms of an electronic (e-commerce) transaction, in which a cloud-based application is a payment application 20, and the data center 6 processes VTM messages to transfer and load content in the form of a monetary value to and from each party's virtual store, so as to enable a purchase transaction. However, it will be appreciated that the present technique is not limited to such embodiments. In fact, those of ordinary skill in the art will recognise that the techniques described herein can be used in any scenario in which it is desired to securely store and transfer information content (of any kind) between users of a cloud-based system. For example, a company may choose to implement an embodiment of the present technique to enable its employees and partners to store and access company information stored in a cloud based storage system. In this case, the cloud-based application 20 executing on the cloud host 4 may operate to handle user (eg. employee) requests to retrieve or store files or data, and the data center 6 may be managed by the company to provide secure encryption/decryption of the information being stored in cloud-based storage.

In the foregoing description, the payment application 20 and data center 6 are managed by a payment services provider, which is separate from the cloud services provider and the merchant. However, while it is contemplated that a separation between the cloud services provider and the payment services provider will be important, any party (including, for example, the merchant or the cloud services provider) capable of managing the data center 6 may operate as the payment services provider.

In the foregoing description, the context database 22 includes a log field 40 for recording transaction information related to transfers may by or on behalf of each virtual store. However, this is not essential. If desired, the log field 40 may be saved in a transactions database that is separate from the context database 22. In this case, the methods described above with reference to FIGS. 3-4 may be modified as appropriate to ensure that the transaction log (or relevant parts thereof) can be properly processed and updated.

The embodiment(s) of the invention described above is(are) intended to be exemplary only. The scope of the invention is therefore intended to be limited solely by the scope of the appended claims.

We claim:

1. A cloud-based information storage and transfer system for use in a cloud computing environment including a cloud host system connected to a data network, the cloud host system being configured to provide cloud based storage and computing services to subscribers through the data network, the system comprising:
a data center connected to the data network, the data center configured to provide data processing functions and cryptographic protection of data using one or more secret keys maintained by the data center;
an application executing on the cloud host system, the application configured to interact with the data center to store and retrieve information to and from the cloud based storage, at least a portion of the information being cryptographically protected by the data center.

2. The cloud-based system as claimed in claim 1, wherein the data center comprises at least one computer and a non-transitory machine-readable storage medium storing at least one secret key for cryptographically protecting data processed by the data center.

3. The cloud-based system as claimed in claim 1, wherein the data center is independent of the cloud host system.

4. The cloud-based system as claimed in claim 1, wherein the data center is configured to communicate with the application via a secure connection through the data network.

5. The cloud-based system as claimed in claim 1, wherein the application is configured to:
receive a request message containing ID information identifying a data record stored in the cloud based storage;
retrieve the data record from the cloud based storage based on ID information; and
forward at least the retrieved data record to the data center.

6. The cloud-based system as claimed in claim 5, wherein forwarding at least the retrieved data record to the data center, comprises also forwarding the request message to the data center.

7. The cloud-based system as claimed in claim 1, wherein the application is configured to:
receive a data record from the data center; and
store the data record in the cloud based storage.

8. The cloud-based system as claimed in claim 7, wherein the application is further configured to:
receive security information including either one or both of a checksum and a digital signature from the data center; and
verify an integrity of the data record based on the received security information.

9. The cloud-based system as claimed in claim 1, wherein the application is configured to:
receive a message from the data center; and
forward the message to a client of the cloud-based system.

10. The cloud-based system as claimed in claim 9, wherein the application is further configured to:
receive security information including either one or both of a checksum and a digital signature from the data center; and
verify an integrity of the message based on the received security information.

11. The cloud-based system as claimed in claim 1, wherein the data center is configured to:
receive a data record from the application;
decrypt an encrypted portion of the data record using at least one of the one or more secret keys maintained by the data center; and
process the data record in accordance with predetermined processing rules.

12. The cloud-based system as claimed in claim 11, wherein the data center is further configured to validate an integrity of un-encrypted portions of the received data records record using at least one of the one or more secret keys maintained by the data center.

13. The cloud-based system as claimed in claim 1, wherein the data center is configured to:
generate a data record in accordance with predetermined processing rules;
encrypt a predetermined portion of the data record using at least one of the one or more secret keys maintained by the data center; and
forward the encrypted data record to the application.

14. The cloud-based system as claimed in claim 13, wherein the data center is further configured to:
generate security information including either one or both of a checksum and a digital signature using the data record and at least one of the one or more secret keys maintained by the data center; and
forward the generated security information to the application.

15. The cloud-based system as claimed in claim 1, wherein each data record contains context information defining a respective context of each one of a plurality of virtual stores, and wherein the application is a secure transfer application executing on the cloud host and configured to:
respond to a transfer request message to transfer content from a subscriber's virtual store by:
retrieving a respective data record containing context information of the subscriber's virtual store from the cloud based storage; and
forwarding the transfer request message and the respective data record to the data center for processing; and
respond to a load request message to load content to a subscriber's virtual store by:
retrieving a respective data record containing context information of the subscriber's virtual store from the cloud based storage; and
forwarding the load request message and the respective data record of the subscriber to the data center for processing.
